(19) United States
(12) Patent Application Publication
(10) Pub. No.: US 2008/0140445 A1
(43) Pub. Date: Jun. 12, 2008

(54) CUSTOMIZED HEALTH ADVERTISING

(75) Inventor: Gang Wang, Frederick, MD (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/608,563

(22) Filed: Dec. 8, 2006

(51) Int. Cl. G06Q 30/00; G06Q 50/00

(52) U.S. Cl. 705/2; 705/14

(57) ABSTRACT

Systems, methods and computer-executable instructions for customizing health-related ads are described herein. By way of example, a system stored on computer-readable media can customize health-related advertising content. The system can comprise a collection component to aggregate data relating to a patient's health, a decision component to decide whether the patient should receive an advertisement from the advertiser and a customization component to adapt the advertising content to be presented to the patient based on at least some of the data.

### BACKGROUND

Consumers are becoming increasingly educated about health issues in general and about their own personal medical conditions in particular. Often times, patients arrive at their healthcare providers well-armed with information about the latest scientific breakthroughs and newly approved medications. The ease of accessing health information online has helped to fuel this growing interest. Savvy healthcare providers and medically-related businesses recognize this growing consumer awareness and are harnessing the power to influence consumer choices through advertising. However, existing direct-to-consumer (DTC) channels for health advertising are of limited bandwidth and not cost-effective.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Although DTC advertising has many benefits for advertisers, existing DTC channels are generic and do not deliver ads targeted to an individual's health condition and history. Effective DTC advertising can be accomplished, for instance, by combining together various players (such as pharmaceutical companies, patients and healthcare providers) to customize the content and delivery targets of DTC advertisements. A DTC entity (e.g., an information escrow service or clearinghouse agent) can work together with a vendor (e.g., a potential advertiser) to develop advertisement content as well as rules or criteria for determining whether goods/services/procedures provided by the vendor will benefit a particular category of patient and for customizing the advertisement content according to a patient's specific condition. The DTC entity (or another entity) then can develop a computer program to implement the rules or criteria. The DTC entity (or another entity) can collect patient information and apply the computer program to the patient information in order to determine advertising targets and to customize the content delivered to the targets (e.g., patients or healthcare providers). The DTC entity (or another entity) then can bill the vendor for the advertising service, for instance, based on the number of advertisements sent out or the number of products purchased by an individual.

Advertisements can be of any type including but not limited to ads pertaining to health-related information, such as ads for a medication, supplement or a surgical procedure or a healthcare provider alert regarding a patient's condition. Advertisers can be, for instance, any health-related entity including but not limited to pharmaceutical companies, pharmacies, veterinary pharmaceutical companies, nutritional supplement manufacturers, physicians, pharmacists, chiropractors, podiatrists, dentists, hospitals, clinics, laboratories, radiology centers, surgery centers, over-the-counter (OTC) medication distributors and medical supply companies. The advertising content can be of any suitable type, such as text, audio or video. Any suitable advertising modality can be employed to deliver the ads, for instance an electronic ad (e.g. delivered by email or personalized TV ad) or a hard copy ad (e.g., delivered by regular mail).

The advertising content can be provided to any suitable entity, such as a healthcare provider (e.g., a hospital, doctor, clinic, pharmacy, lab, etc.), an individual or a group of individuals that use or could potentially use healthcare services or goods (e.g. a patient or healthcare consumer/user). As used herein, healthcare services or goods include but are not limited to office visits, procedures, surgeries, laboratory services, radiological services, prescription medication, OTC medication, supplements, prosthetics, medical supplies, veterinary services/goods and/or medical equipment.

The patient data can be provided explicitly by a patient or automatically culled from existing records by using, for instance, machine-learning/data-mining algorithms. The data collected can be of any suitable type, for instance, health-related information such as a person's age, gender, medical history, family medical history, genetic information, vital signs, lab tests, imaging studies, etc. The mechanism to determine whether an ad is pertinent to a particular individual can be of any suitable type, for instance, a set of IF-THEN rules and a rules engine for finding a rule match (e.g., a Rete algorithm). Additionally or alternatively, the computer program can be an adaptive system and learn from prior experience

Moreover, in order to protect an individual's privacy, information about an individual can be collected, analyzed and/or stored only by those with a need-to-know (e.g., healthcare providers who utilize the information to provide healthcare services to the individual). Additionally or alternatively, an individual can be asked to consent to the dissemination of the individual's information to other parties.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of a system for generating advertising content for an advertiser.

FIG. 2 is a block diagram of another example of a system for generating advertising content for an advertiser.

FIG. 3 is a block diagram of another example of a system for generating advertising content for an advertiser.

FIG. 4 is a block diagram of another example of a system for generating advertising content for an advertiser.

FIG. 5 is a block diagram of another example of a system for generating advertising content for an advertiser.

FIG. 6 is a block diagram of another example of a system for generating advertising content for an advertiser.

FIG. 7 is a block diagram of another example of a system for generating advertising content for an advertiser.

FIG. 8 is a block diagram of another example of a system for generating advertising content for an advertiser.

FIG. 9 is a block diagram of another example of a system for generating advertising content for an advertiser.

FIG. 10 is a block diagram of yet another example of a system for generating advertising content for an advertiser.

FIG. 11 is a flowchart representing one example of a method of delivering a third party's health-related advertisement of a good and/or service to a consumer.

FIG. 12 is a flowchart representing another example of a method of delivering a third party's health-related advertisement of a good and/or service to a consumer.

FIG. 13 is a flowchart representing one example of a method of generating targeted healthcare advertising relating to an advertiser's treatment.

FIG. 14 is a flowchart representing another example of a method of generating targeted healthcare advertising relating to an advertiser's treatment.

FIG. 15 is a flowchart representing one example of a method of generating targeted healthcare advertising relating to an advertiser's treatment.

FIG. 16 is a block diagram of one example of a system for providing alerts to a healthcare provider.

FIG. 17 is a flowchart representing one example of a method of providing alerts to a healthcare provider.

### DETAILED DESCRIPTION

The subject matter described herein facilitates customizing and targeting the delivery of health-related information (such as advertisements). By way of example, the subject matter includes a business method. In this example, the business process entails developing advertising content and rules for determining if goods/services/procedures will be of interest to (e.g., benefit) an entity (e.g., a patient, a group of potential healthcare users, an animal owner, etc.) and for determining how to customize the advertising content based on information collected about the entity. The development process can be conducted in collaboration with the advertiser but need not be. Information about the entity can be collected and a computer program can be developed to implement the rules. Using the computer program, targeted advertising content can be generated and personalized ads can be delivered to the entity. The advertiser can be charged accordingly for the service. For instance, the advertiser can be invoiced based on the total number of targeted ads sent out. In performing the business method, all applicable laws can be complied with, for instance, patient privacy laws. As such, the business method can include obtaining the entity's consent to collect information and to deliver ads.

To encourage consumer participation, incentives can be provided. For example, coupons for discounts on goods and/or services can be offered to participating consumers. Another way to encourage participation is by minimizing the effort needed to provide information. For instance, healthcare users can be presented with a series of questions to answer to input their medical/health/wellness information. By way of another example, machine learning/pattern recognition algorithms can be employed to mine healthcare provider data/databases in order to collect data.

By way of another example, the subject matter includes a rule-based system (e.g., Rete algorithm to implement a rule-based system) to determine whether an ad should be sent to particular consumers and to personalize the content of the ad. The system collects data about participating consumers and applies rules to the data in order to make decisions regarding who should receive an ad and what information should be in an ad. In this example, rules, such as IF-THEN rules, are employed to determine if a particular consumer or group of consumers would be interested in an advertiser's ads. The rules can include but are not limited to determining suitable drugs, procedures, medical equipment, insurance reimbursement and drug interactions. For instance, a rule can identify all consumers entered into the system who have had a heart attack in the last 6 weeks and target those consumers as being suitable for receiving ads about a particular cholesterol lowering drug. Another rule, for example, can identify patients who would benefit from a gestational diabetes drug. Such a rule could be structured as follows:
IF a patient is a female and is pregnant and in 2^{nd} trimester and age greater than 35 and is otherwise healthy except gestational diabetes THEN send her an advertisement for the gestational diabetes medication.

### The system can obtain the information about patients from healthcare providers, for instance, hospitals.

The subject matter is not limited to static IF-THEN rules. The systems and methods disclosed herein include, for instance, learning feedback loops. By way of example, an ad for a medication can be delivered according to an IF-THEN rule and delivered in the ad can be a customized coupon with a tracking number. If a patient uses the coupon to purchase the drug recommended in the ad, the tracking number can be used to keep track of which and how many patients buy the drug. If the numbers are low, the system can reassess whether the IF-THEN rules are appropriate using any suitable technique (e.g., machine learning). Optionally, a human can modify the rules in whole or in part according to the feedback.

As discussed above, the content of the ad can be personalized, for instance, based on gender such as in the situation of a drug that should not be taken during pregnancy. Accordingly, female consumers would receive an ad for the drug containing a pregnancy warning and male consumers would receive an ad without such a warning. By way of another example, if a particular insurance company will not reimburse for a drug, a rule can indicate that those consumers with that type of health insurance should not receive the ad. Alternatively, the ad can be customized for those consumers without insurance coverage to indicate that the drug is not covered by their insurance and/or, for instance, a coupon can be included to provide those consumers with a discount. By way of yet another example, if a consumer is taking medication A and medication B is known to interact with medication A, the ad for medication B can contain a warning to seek medical advice if the consumer takes both medications A and B and experiences the symptoms of an interaction.

The collected data can be monetized by, for instance, charging advertisers or vendors for ad delivery. Fees can be calculated in any suitable manner such as based on the total number of ads delivered or based on whether a consumer purchases a medication after receiving an ad for the product.

By way of yet another example, the subject matter also includes a healthcare provider (e.g. a hospital, doctor, clinic, pharmacy, lab, etc.) back-up system to alert healthcare providers about, for instance, medications relevant to their patients' care. This back-up system can help to reduce medical errors such as those caused by a physician prescribing a less effective medication. In this example, a database of patient information can be mined using machine learning/pattern recognition techniques to determine patient conditions. When a patient is identified as being likely to benefit from the administration of a particular medication that the patient is not currently taking, the patient's doctor, for instance, can be sent an alert about the medication. Examples of data mining methods include but are not limited to a neural networks, expert systems, Bayesian belief networks, fuzzy logic and the like as well as combinations of various artificial intelligence techniques capable of discerning patterns. Optionally, a human intervention step can be added to the process in order to mine the data. The data to be mined can include but is not limited to a patient's medical history, family medical history, vital signs, laboratory values, EKG information, etc.

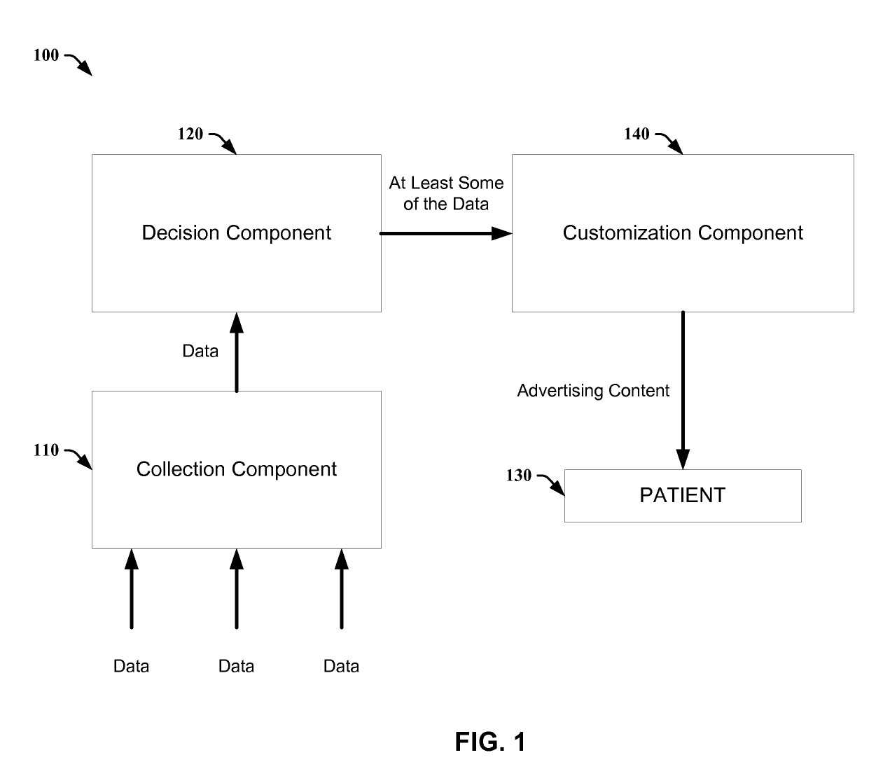

FIG. 1 schematically illustrates one example of a system 100 for generating advertising content for an advertiser. The system includes a collection component 110 to aggregate data relating to a patient's health, a decision component 120 to decide whether the patient 130 should receive an advertisement from the advertiser and a customization component 140 to adapt the advertising content to be presented to the patient based on at least some of the data relating to the patient's health. The system 100 can be generated at least in part by creating a set of decision rules in collaboration with the advertiser and configuring the decision component 120 to implement the set of decision rules to decide whether the patient 130 should receive the advertisement from the advertiser. Any or all of the components 110, 120, 140 can be located at the same site (e.g., a healthcare provider site) or at different sites (e.g., different healthcare provider sites, a mixture of healthcare provider sites and non-healthcare provider sites or different non-healthcare provider sites).

The components 110, 120, 140 can be implemented by software or combinations of software and hardware in any of the ways described above (e.g., data mining). The components 110, 120, 140 can be the same process executing on a single or a plurality of computers or multiple processes executing on a single or a plurality of computers. The advertising content can be delivered to the patient 130 in any suitable form, such as in electronic form (e.g., email, file, personalized TV ad, etc.) or a hard copy (e.g., by traditional mail).

The collection component 110 can collect any type of data including but not limited to biological, pathophysiological, physiological, medical, healthcare and/or otherwise health-related data. The data can be, for example, a medication, a symptom, and/or genetic information. The collection component 110 can collect data in any form including but not limited to electronic, textual, graphical, photographic, sound, speech, video, multimedia and the like. The data can be provided to the collection component 110 from any input means, such as a PDA, telephone, bar code reader, computer, keyboard, mouse, microphone, touchscreen, database, cell phone, etc. The collection component 110 can automatically obtain data, such as by querying a provider database (not shown). Examples of data-mining methods suitable for querying a database include but are not limited to neural networks, expert systems, Bayesian belief networks, fuzzy logic and the like as well as combinations of various artificial intelligence techniques capable of discerning patterns. Optionally, a human intervention step can be added to the process in order to obtain the data.

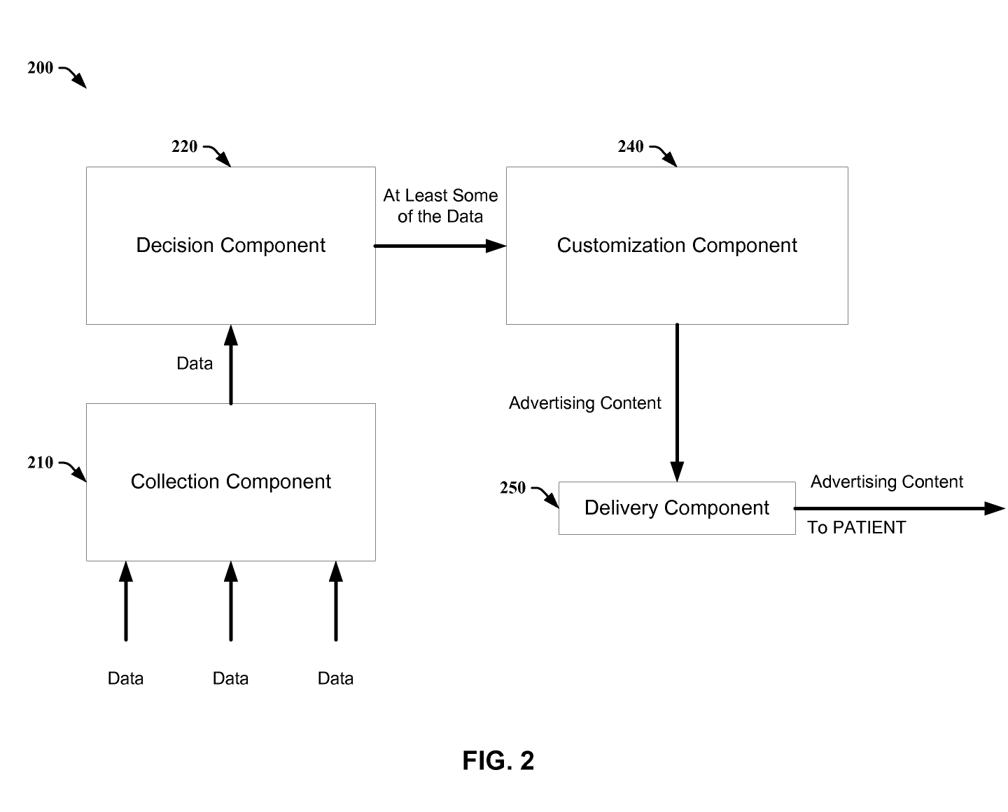

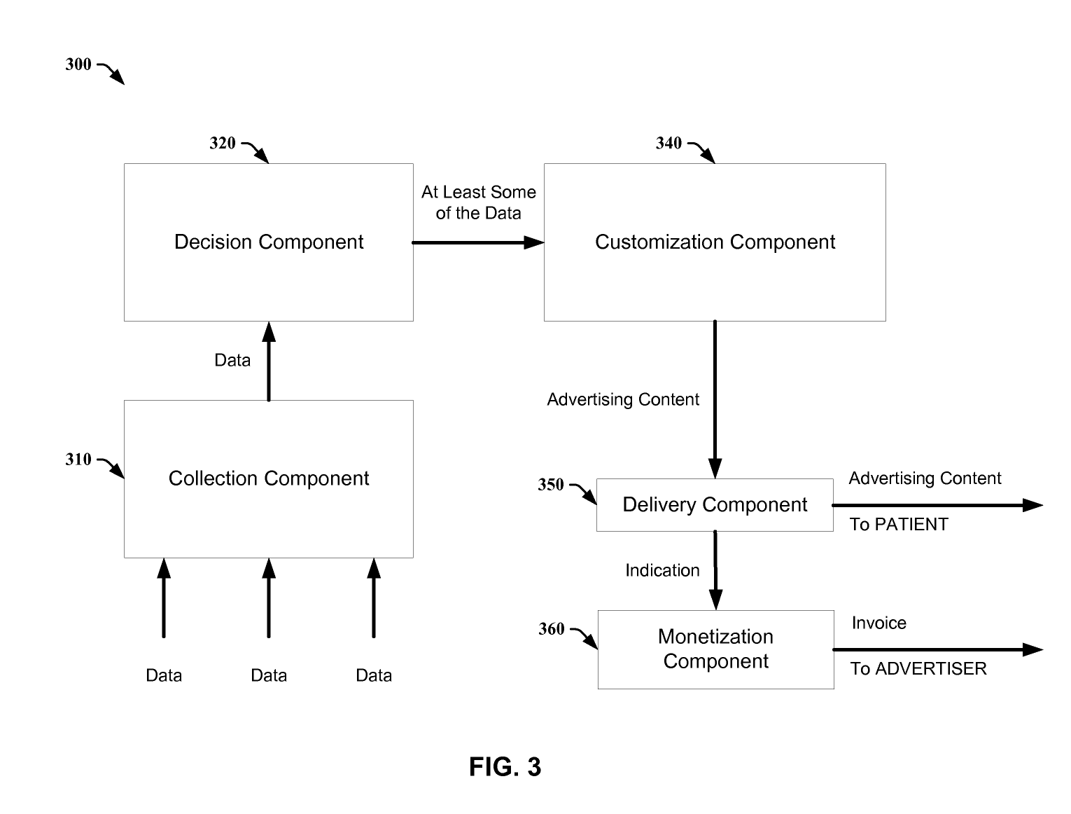

FIG. 2 schematically illustrates another example of a system 200 for generating advertising content for an advertiser. The system 200 is similar to the system 100 shown in FIG. 1 and further includes a delivery component 250 to present the advertising content to the patient. The delivery component 250 can deliver the advertising content to the patient in, for instance, electronic form, such as by an email or other electronic alert. FIG. 3 schematically illustrates another example of a system 300 for generating advertising content for an advertiser. The system 300 is similar to the system 200 shown in FIG. 2 and further includes a monetization component 360 to receive an indication that the advertising content has been presented to the patient and to invoice the advertiser for presenting the advertising content to the patient. The components 210, 220, 240, 250, 310, 320, 340, 350, 360 can be implemented by software or combinations of software and hardware in any of the ways described above. For instance, the delivery component 250, 350 can be configured to present the advertising content to the patient in a visual manner and/or an auditory manner. Any or all of the components 210, 220, 240, 250, 310, 320, 340, 350, 360 can be located at the same site (e.g., a healthcare provider site) or at different sites (e.g., different healthcare provider sites, a mixture of healthcare provider sites and non-healthcare provider sites or different non-healthcare provider sites).

The advertising content can be of any type including but not limited to ads pertaining to health-related information, such as an ad for a medication, supplement or a healthcare service (e.g. a surgical procedure). Advertisers can be, for instance, any health-related entity including but not limited to pharmaceutical companies, pharmacies, veterinary pharmaceutical companies, nutritional supplement manufacturers, physicians, pharmacists, chiropractors, podiatrists, dentists, hospitals, clinics, laboratories, radiology centers, surgery centers, over-the-counter (OTC) medication distributors and medical supply companies.

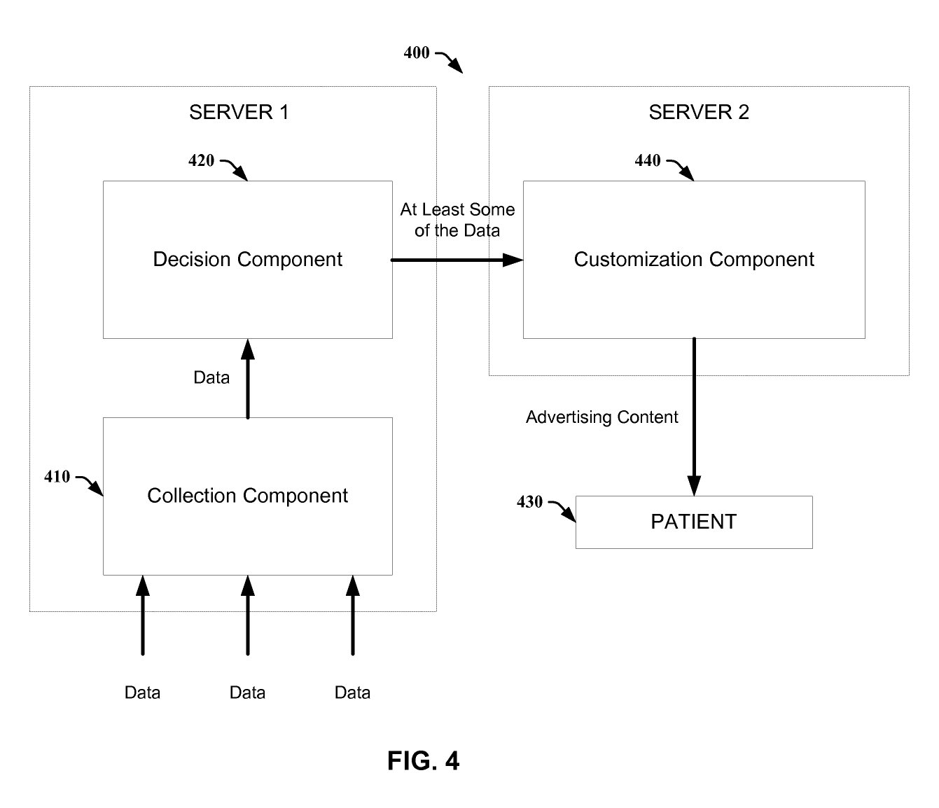

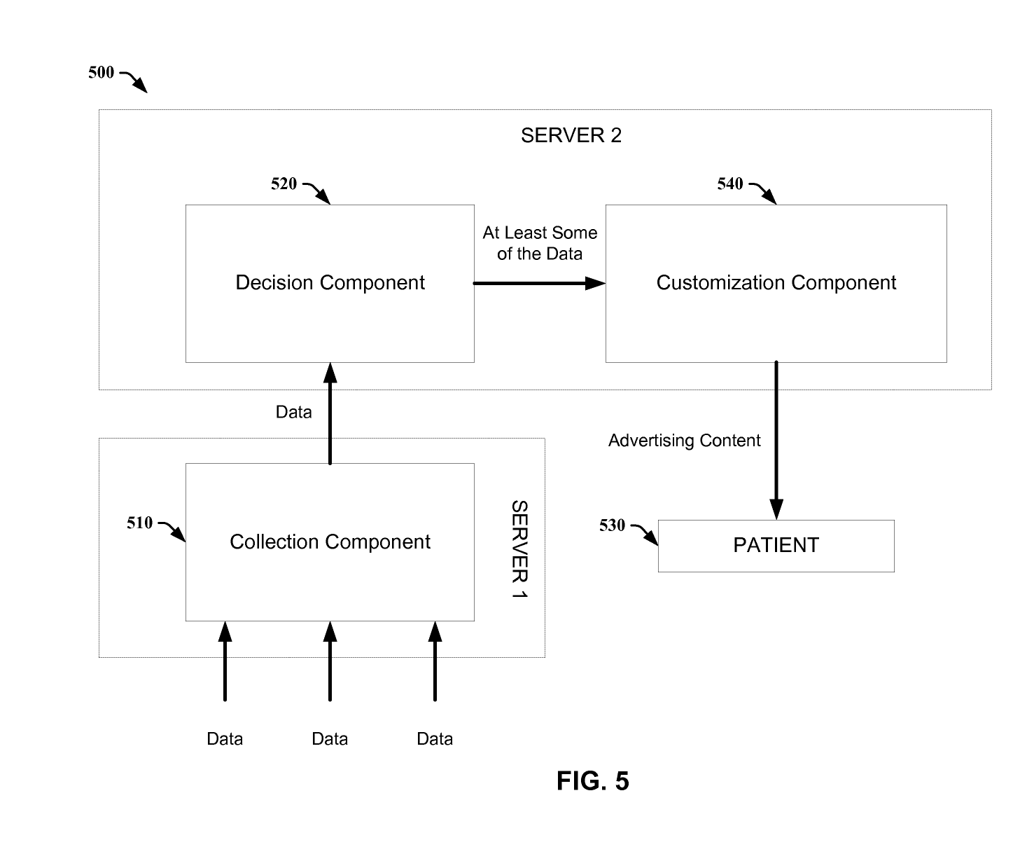

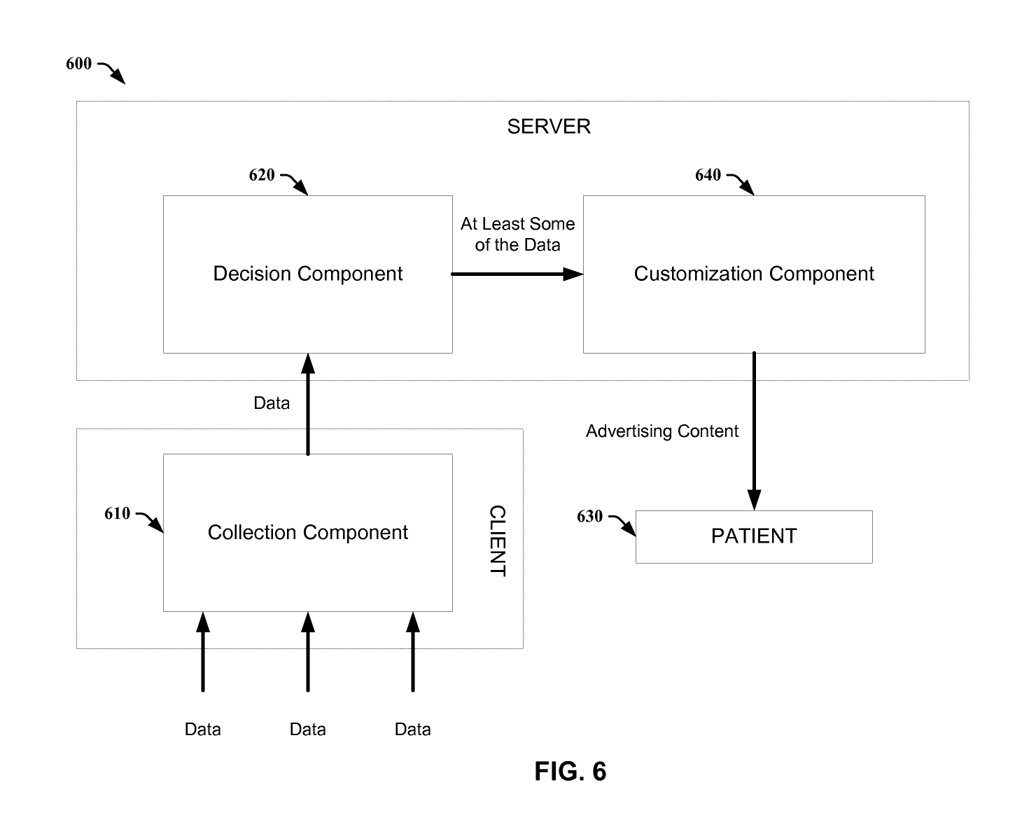

FIGS. 4 and 5 schematically illustrate other examples of systems 400, 500 for generating advertising content for an advertiser. The systems 400, 500 are similar to the system 100 shown in FIG. 1 with the various components being distributed among two or more servers. FIG. 6 schematically illustrates another example of a system 600 for generating advertising content for an advertiser. In this system 600, the collection component 610 is located on a client side.

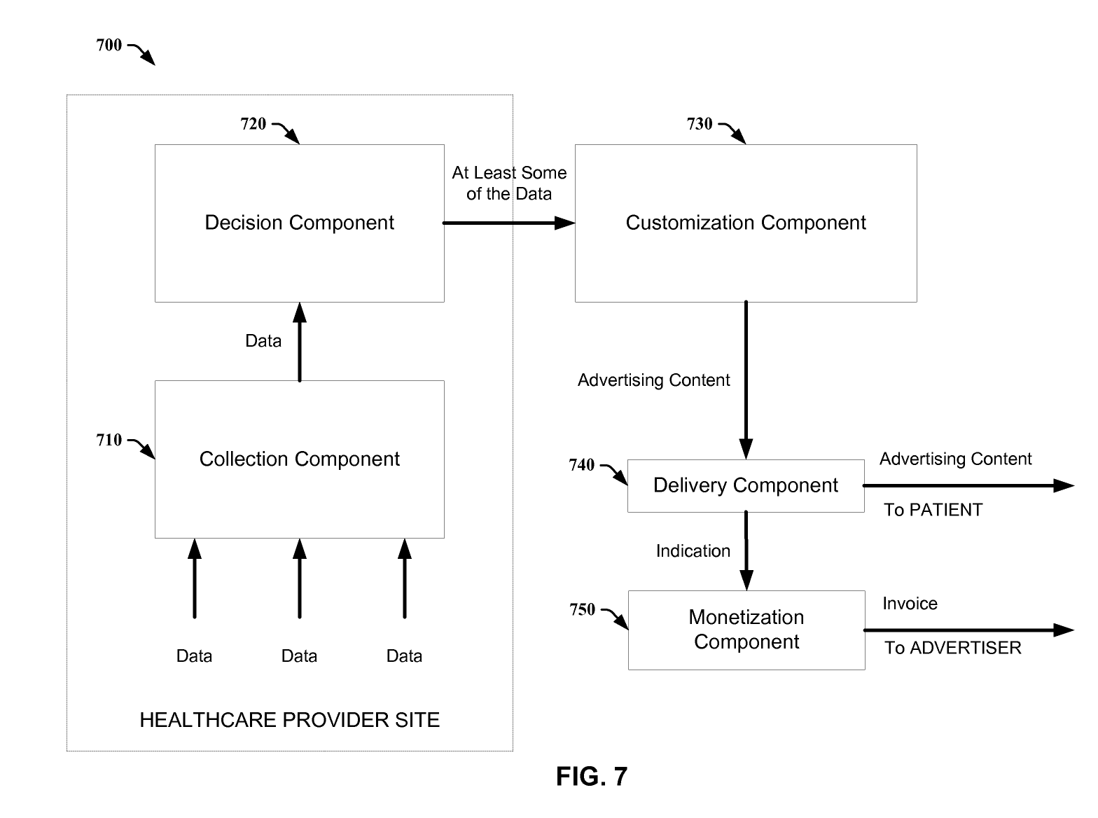

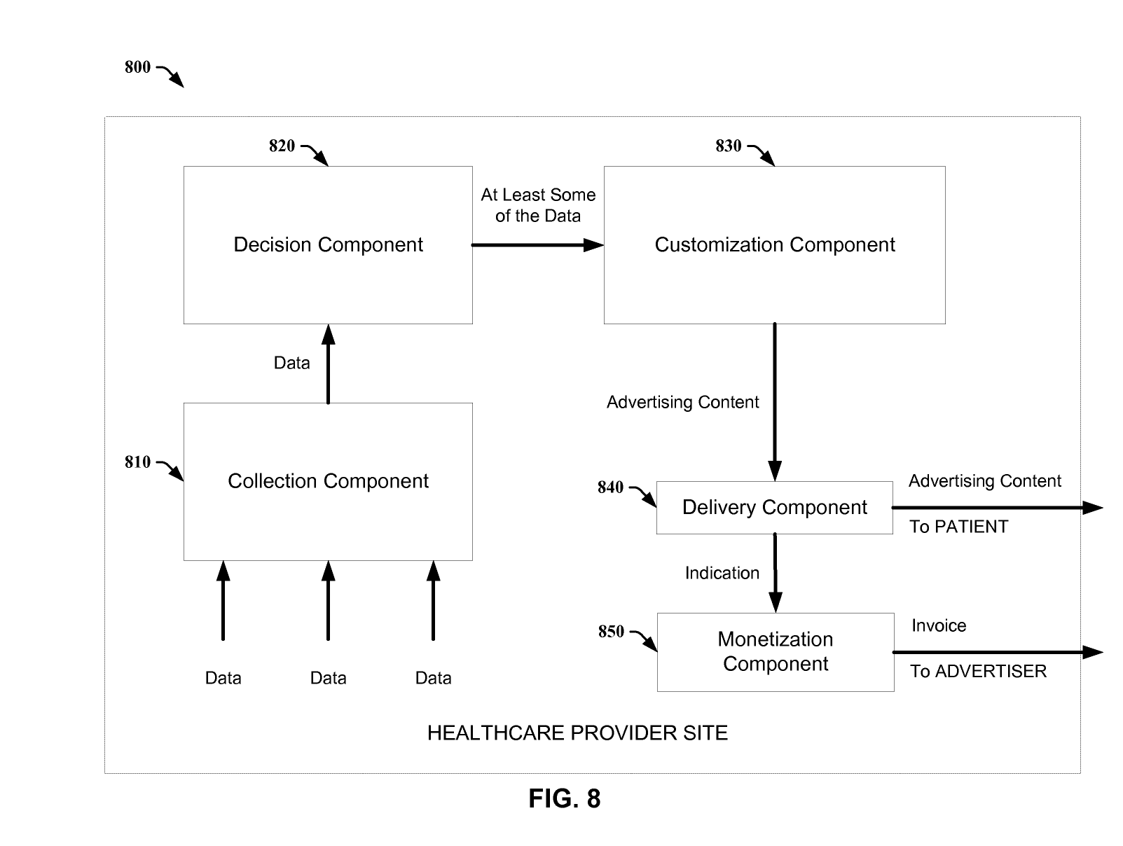

FIGS. 7 and 8 schematically illustrate other examples of systems 700, 800 for generating advertising content for an advertiser. As shown in FIGS. 7 and 8, various components of the systems 700, 800 can reside on a healthcare provider's site. These embodiments provide added privacy to the participating healthcare users because the users' confidential health information does not have to be sent to third parties outside of the healthcare provider systems. As shown in FIGS. 7 and 8, a portion or the entirety of the systems 700, 800, respectively can be located in the healthcare provider's system.

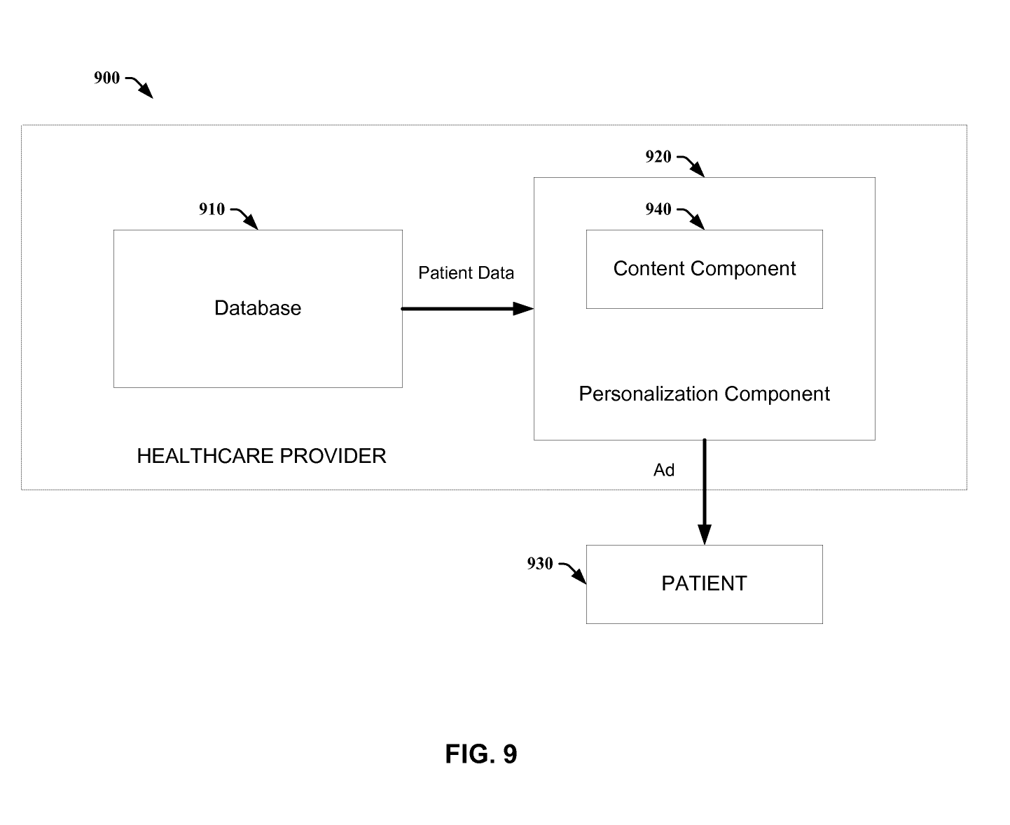

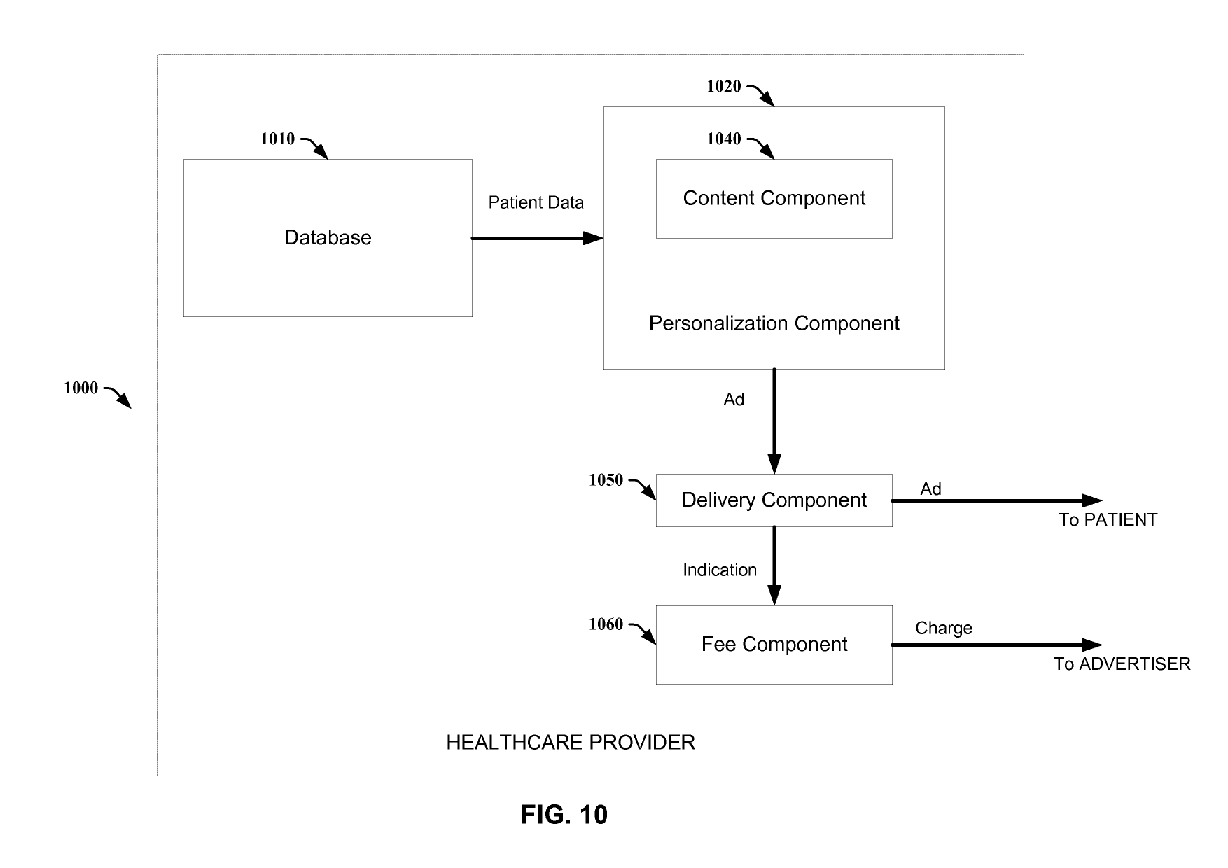

FIG. 9 schematically illustrates a healthcare provider-based system 900 for generating an ad. The system 900 includes a database 910 for storing patient data, a personalization component 920 for determining those patients 930 who should receive an ad and having a content component 940 for personalizing the ad. The ad can be in electronic or hard copy form. FIG. 10 schematically illustrates another healthcare provider-based system 1000 for generating an ad similar to the system 900 shown in FIG. 9 and further including a delivery component 1050 for delivering the ad to the patient and a fee component 1060 for charging an advertiser a fee after receiving an indication that the ad has been delivered to the patient 1030.

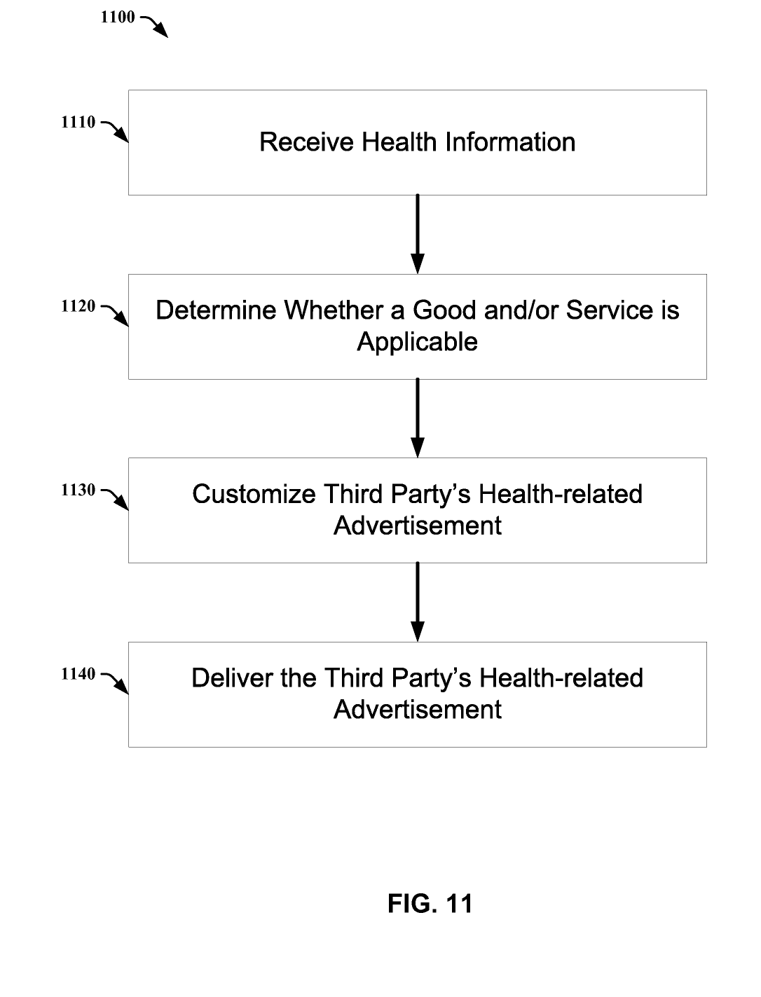

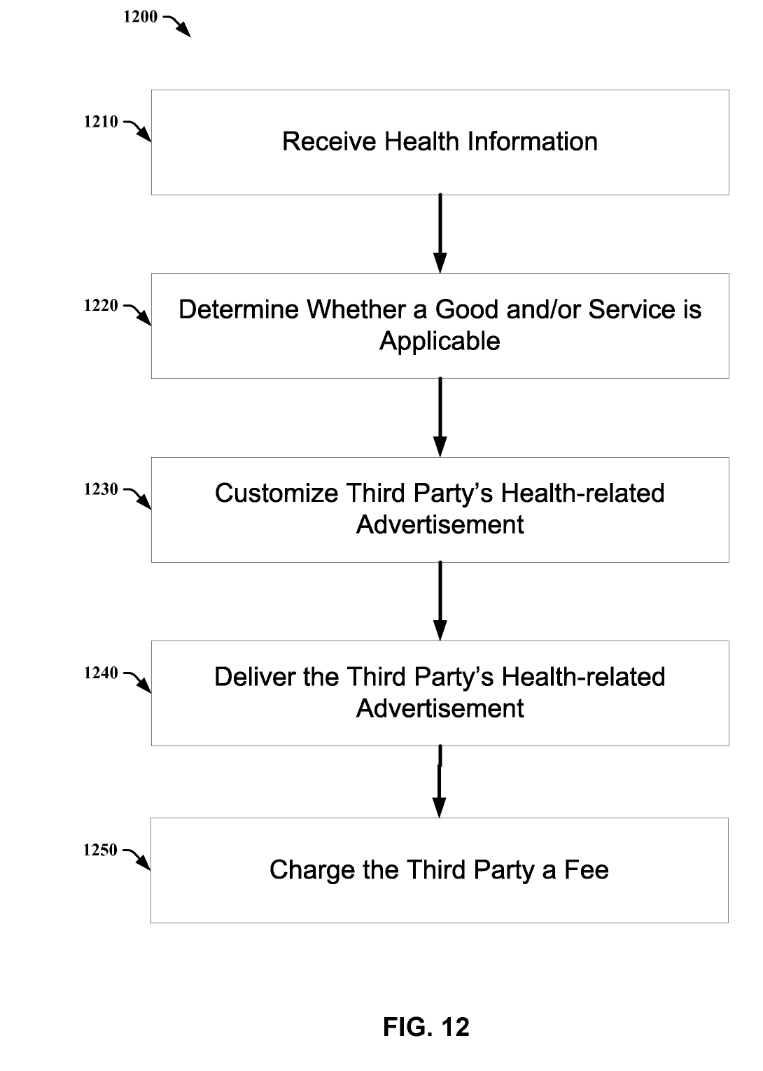

FIG. 11 is a flowchart representing one example of a method 1100 of delivering a third party's health-related advertisement of a good and/or service to a consumer. At step 1100, some or all of the consumer's health information is received and at step 1120 a determination is made whether the good and/or service is applicable to the consumer (e.g., determining whether the consumer is likely to benefit from the advertisement, utilizing a set of rules developed in conjunction with the third party, employing IF-THEN rules and rules engine, etc.). The determination is based on the received consumer's health information. At step 1130 the third party's health-related advertisement is customized according to the consumer (e.g., according to gender, interacting drugs, utilizing a set of rules developed in conjunction with the third party, etc.) and at step 1140, the advertisement is delivered to the consumer. As shown in FIG. 12, the third party can be charged a fee 1250 for the service. The third party can be any of the entities described above, such as a pharmaceutical company or a healthcare provider.

Any type of health information can be received including but not limited to biological, pathophysiological, physiological, medical, healthcare and/or otherwise health-related data. The data can be, for example, a medication, a symptom, and/or genetic information. The information can be received in any form including but not limited to electronic, textual, graphical, photographic, sound, speech, video, multimedia and the like. The information can be provided from any input means, such as a PDA, telephone, bar code reader, computer, keyboard, mouse, microphone, touchscreen, database, cell phone, etc. The information can be automatically obtained, such as by querying a provider database (not shown). Examples of data-mining methods suitable for querying a database include but are not limited to neural networks, expert systems, Bayesian belief networks, fuzzy logic and the like as well as combinations of various artificial intelligence techniques capable of discerning patterns. Optionally, a human intervention step can be added to the process in order to obtain the information.

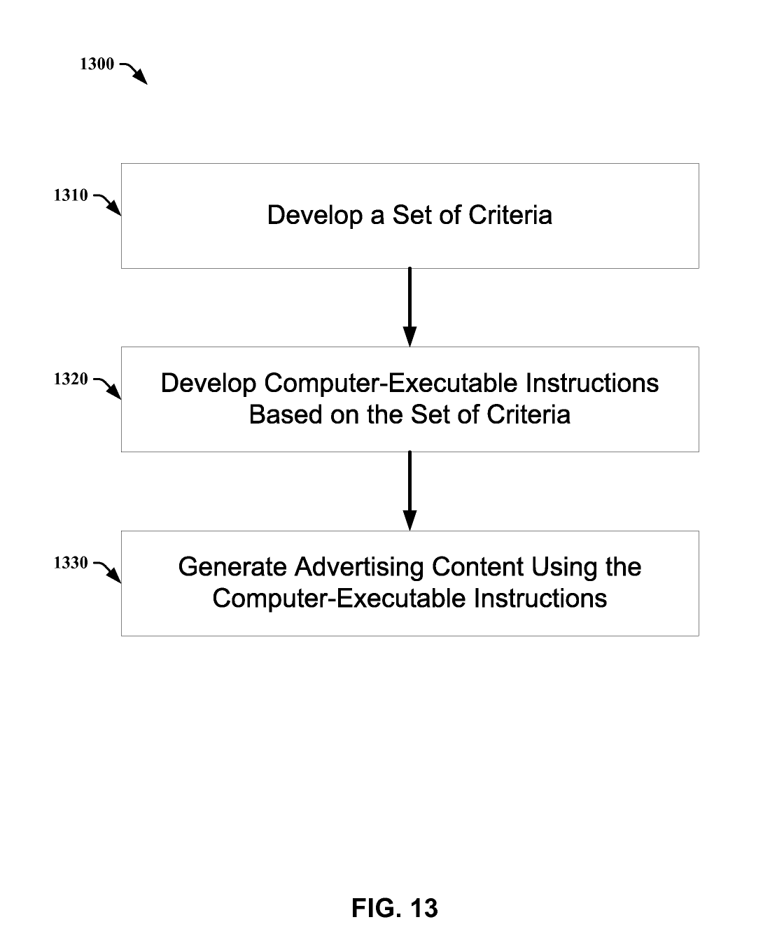

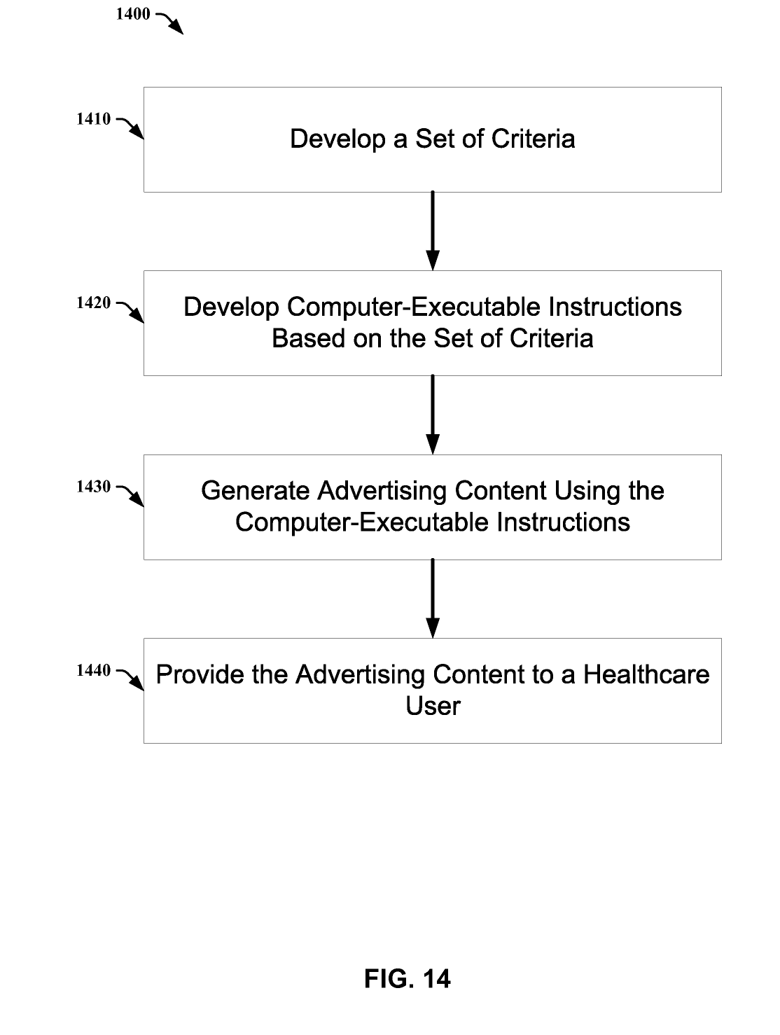

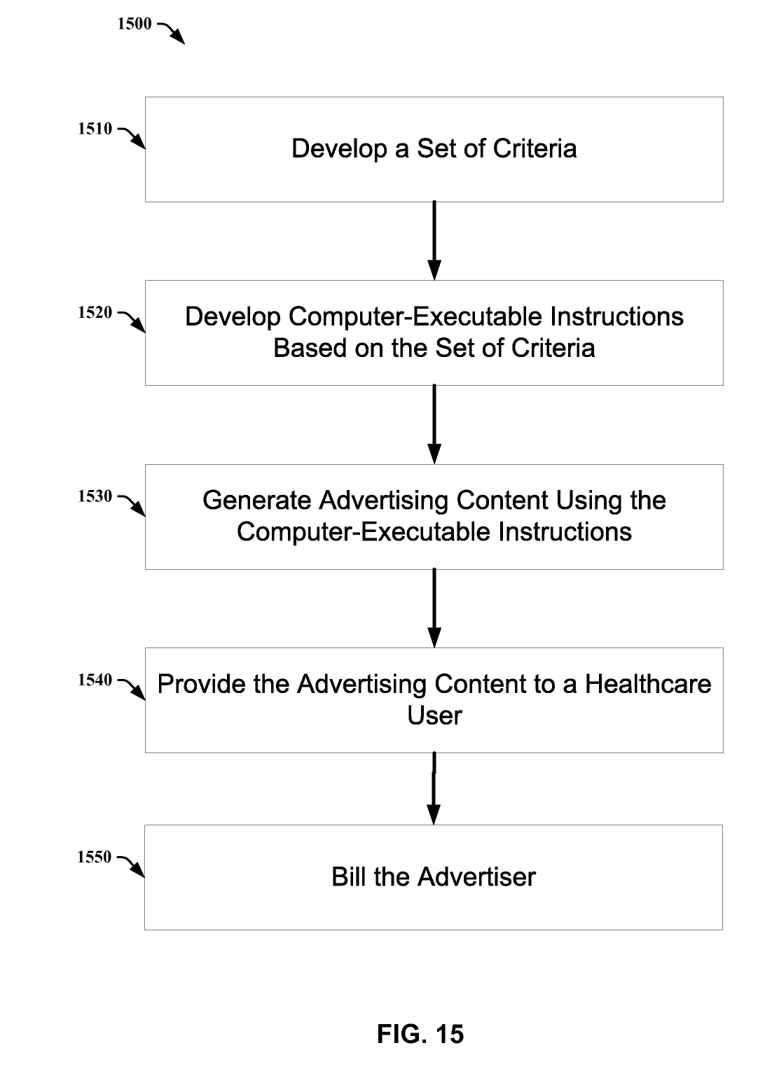

FIG. 13 is a flowchart representing one example of a method 1300 of generating targeted healthcare advertising relating to an advertiser's treatment. At step 1310 a set of criteria relating to the advertiser's treatment is developed with the aid of the advertiser. The set of criteria are used to develop 1320 computer-executable instructions for determining if one or more healthcare users are likely to benefit from the advertiser's treatment. At step 1330, advertising content relating to the advertiser's treatment is generated using the computer-executable instructions. As shown in FIGS. 14 and 15, the advertising content can be provided 1440 to at least one of the one or more healthcare users and the advertiser can be billed 1550 for providing the advertising content to the at least one of the one or more healthcare users.

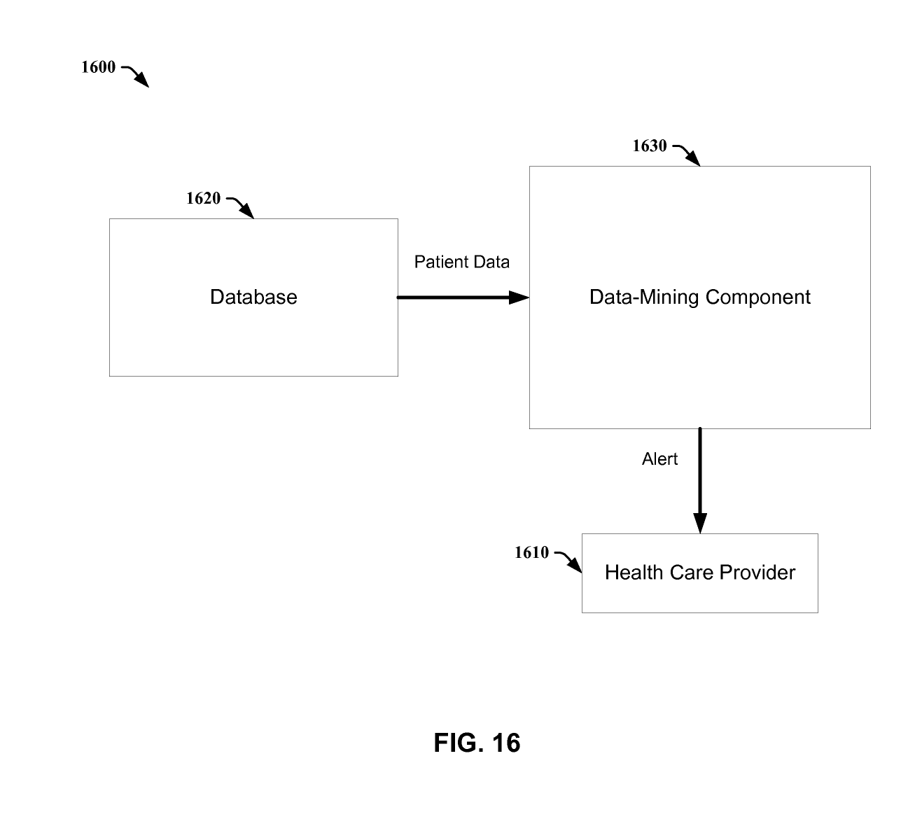

FIG. 16 is a block diagram of one example of a system 1600 for providing alerts to healthcare providers 1610 (e.g., a hospital, doctor, clinic, pharmacy, lab, etc.). The system 1600 can be utilized to help to reduce medical errors such as those caused by a physician prescribing a less effective medication (e.g., by sending the physician an alert relating to newer medications more relevant to a patient's condition). The system 1600 includes a database of patient information 1620 and a data-mining component 1630. The data-mining component 1630 mines the database of patient information 1620 using any suitable technique, such as machine learning/pattern recognition techniques, to determine patient conditions. The patient information can include but is not limited to a patient's medical history, family medical history, vital signs, laboratory values, EKG information, etc. If the data-mining component 1630 identifies a patient as requiring an intervention, for instance as being likely to benefit from the administration of a particular medication that the patient is not currently taking, an alert can be sent to the patient's healthcare provider 1610.

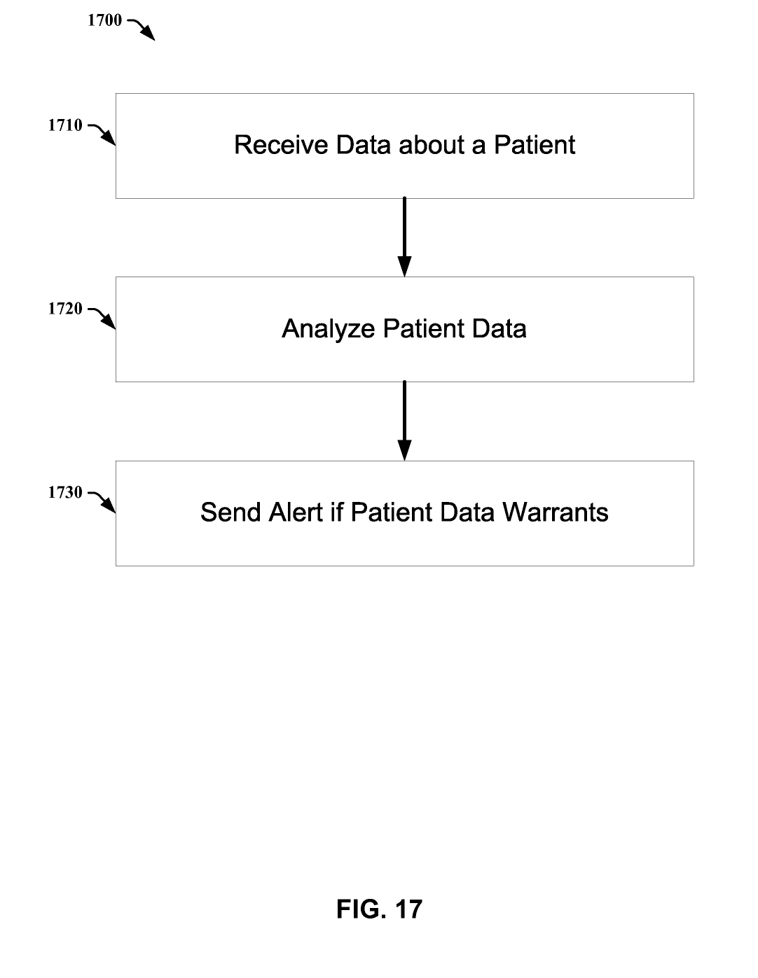

FIG. 17 is a flowchart representing one example of a method 1700 of providing alerts to a healthcare provider. At step 1710, data about a patient is received. The data is analyzed at step 1720 to determine if an alert should be sent to the patient's healthcare provider. If the analysis indicates that the patient's healthcare provider should be alerted, an alert is sent as shown in step 1730. Any suitable method can be use to analyze the data, such as the use of a Rete algorithm, neural networks, expert systems, Bayesian belief networks, fuzzy logic and the like as well as combinations of various artificial intelligence techniques. Optionally, human intervention steps (not shown) can be added to the process in order to analyze the data and/or provide feedback to fine-tune the analysis step.

The systems 100, 200, 300, 400, 500, 600, 700, 800, 900, 1000, 1600 described above can be implemented on a network, in whole or in part, by data signals. These manufactured data signals can be of any suitable type and can be conveyed on any type of network. For instance, the systems can be implemented by electronic signals propagating on electronic networks, such as the Internet. Wireless communications techniques and infrastructures also can be utilized to implement the systems.

As used in this application, the term “component” is intended to refer to a computer-related entity, either hardware, a combination of hardware and software, software, or software in execution. For example, a component can be, but is not limited to, a process running on a processor, a processor, an object, an executable, a thread of execution, a program, and a computer. By way of illustration, an application running on a server and/or the server can be a component. In addition, a component can include one or more subcomponents. One or more components can reside within a process and/or thread of execution and a component can be localized on one computer and/or distributed between two or more computers.

The methods 1100, 1200, 1300, 1400, 1500, 1700 can be implemented by computer-executable instructions stored on computer-readable media or conveyed by a data signal of any suitable type. The methods 1100, 1200, 1300, 1400, 1500, 1700 can be implemented at least in part manually. The steps of the methods 1100, 1200, 1300, 1400, 1500, 1700 can be implemented by software or combinations of software and hardware and in any of the ways described above (e.g., mining data to receive some or all of the consumer's health information, customizing the advertisement according to gender, etc.). The computer-executable instructions can be the same process executing on a single or a plurality of computers or multiple processes executing on a single or a plurality of computers. The advertisement can be delivered to the consumer in any suitable form, such as in electronic form (e.g., email, file, personalized TV ad, etc.) or hard copy (e.g., by traditional mail). The methods 1100, 1200, 1300, 1400, 1500, 1700 can be repeated any number of times as needed.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the methods and systems described herein can be practiced with all computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

In regard to the various functions performed by the above described components, computer-executable instructions, means, systems and the like, the terms are intended to correspond, unless otherwise indicated, to any functional equivalents even though the functional equivalents are not structurally equivalent to the disclosed structures. Furthermore, to the extent that the terms “includes,” and “including” and variants thereof are used in either the specification or the claims, these terms are intended to be inclusive in a manner the same as the term “comprising.” Accordingly, the claimed subject matter is intended to embrace all such alterations, modifications, and variations that fall within the spirit and scope of the appended claims.

What is claimed is:

1. A system for generating advertising content for an advertiser, the system stored on one or more computer-readable media, the system comprising:
a collection component to aggregate data relating to a patient's health;
a decision component to decide whether the patient should receive an advertisement from the advertiser; and
a customization component to adapt the advertising content to be received by the patient based on at least some of the data relating to the patient's health.

2. The system of claim 1, further comprising a delivery component to present the advertising content to the patient.

3. The system of claim 2, further comprising a monetization component to receive an indication that the advertising content has been presented to the patient and to invoice the advertiser for presenting the advertising content to the patient.

4. The system of claim 1, wherein the delivery component is configured to present the advertising content to the patient in a visual manner and/or an auditory manner.

5. The system of claim 1, wherein the advertising content pertains at least in part to a medication.

6. The system of claim 1, wherein the advertising content pertains at least on part to one or more healthcare services.

7. The system of claim 6, wherein at least one of the one or more healthcare services is a procedure.

8. The system of claim 1, wherein the system is distributed among two or more servers.

9. The system of claim 1, wherein the collection component is stored on a client side.

10. The system of claim 1, the system generated at least in part by a method comprising:
creating a set of decision rules in collaboration with the advertiser; and
configuring the decision component to implement the set of decision rules to decide whether the patient should be presented with the advertisement from the advertiser.

11. The system of claim 1, wherein the system resides at least in part at a health provider site.

12. Computer-executable instructions for performing a method of delivering a third party's health-related advertisement of a good and/or service to a consumer, the computer-executable instructions stored on one or more computer-readable media, the method comprising:
receiving some or all of the consumer's health information;
determining whether the good and/or service is applicable to the consumer based on the received consumer's health information;
customizing the third party's health-related advertisement according to the consumer; and
delivering the third party's health-related advertisement to the consumer.

13. The computer-executable instructions of claim 12, further comprising charging the third party a fee for delivering the health-related advertisement.

14. The computer-executable instructions of claim 12, wherein the third party is a pharmaceutical company.

15. The computer-executable instructions of claim 12, wherein the third party is a healthcare provider.

16. The computer-executable instructions of claim 12, wherein determining whether the good and/or service is applicable to the consumer based on the received consumer's health information comprises at least utilizing a set of rules developed in conjunction with the third party.

17. The computer-executable instructions of claim 12, wherein customizing the third party's health-related advertisement of the good and/or service according to the consumer comprises at least utilizing a set of rules developed in conjunction with the third party.

18. A method of generating targeted healthcare advertising relating to an advertiser's treatment, the method comprising:
developing a set of criteria relating to the advertiser's treatment with the aid of the advertiser;
developing computer-executable instructions for determining if one or more healthcare users are likely to benefit from the advertiser's treatment based on the set of criteria; and
generating advertising content relating to the advertiser's treatment using the computer-executable instructions.

19. The method of claim 18, further comprising providing the advertising content to at least one of the one or more healthcare users.

20. The method of claim 19, further comprising billing the advertiser for providing the advertising content to the at least one of the one or more healthcare users.
